(19) United States
(12) Patent Application Publication
(10) Pub. No.: US 2025/0260128 A1
(43) Pub. Date: Aug. 14, 2025

(54) ELECTRIC STORAGE DEVICE AND SEPARATOR THEREOF

(71) Applicant: Prime Planet Energy & Solutions, Inc., Tokyo (JP)

(72) Inventor: Yoshitaka MINAMIDA, Kobe-shi (JP)

(21) Appl. No.: 19/038,707

(22) Filed: Jan. 28, 2025

(30) Foreign Application Priority Data
Feb. 13, 2024 (JP) 2024-019226

(51) Int. Cl. H01M 50/463; H01G 11/24; H01G 11/52; H01M 10/0587; H01M 50/103; H01M 50/449

(52) U.S. Cl. CPC H01M 50/463; H01G 11/24; H01G 11/52; H01M 10/0587; H01M 50/103; H01M 50/449

(57) ABSTRACT

Provided is a technique that does not inhibit an intrusion of the electrolytic solution from outside to inside of the electrode assembly, and that can suppress the electrolytic solution from outflowing to the outside from the inside of the electrode assembly. A herein disclosed electric storage device includes the electrode assembly including a positive electrode, a negative electrode, and a separator, includes an electrolytic solution, and includes a case configured to accommodate the electrode assembly and the electrolytic solution. The electric storage device includes a reverse flow inhibiting groove on a surface of the separator. The reverse flow inhibiting groove is a groove in which the electrolytic solution flows from the outside to the inside of the electrode assembly, and is a groove which is in a pattern for inhibiting the electrolytic solution from flowing to the outside from the inside of the electrode assembly.

### CROSS REFERENCE TO RELATED APPLICATIONS

The present application claims the priority based on Japanese Patent Application No. 2024-019226 filed on Feb. 13, 2024, the entire contents of which are incorporated in the present specification by reference.

### BACKGROUND OF THE DISCLOSURE

### 1. Technical Field

The present disclosure relates to an electric storage device, and a separator used for the electric storage device.

### 2. Background

Japanese Patent Application Publication No. 2022-12289 discloses a nonaqueous electrolytic solution secondary battery that includes an electrode assembly, in which a positive electrode, a negative electrode, and a separator are overlaid, and that includes a nonaqueous electrolytic solution which osmoses inside the electrode assembly. Each of the positive electrode and the negative electrode is formed by making an electrode composite material layer containing an electrode active material be applied to coat a surface of an electrode collecting foil being formed in a strip-like shape. The electrode assembly includes an electrolytic solution flow passage that is a flow channel for the nonaqueous electrolytic solution flowing at an inside and an outside of the electrode assembly. Regarding a negative electrode composite material layer, in a case where an area coming into contact with the electrolytic solution flow passage is treated as a damming part and an area positioning at a central side more than the damming part is treated as a liquid retaining part, the damming part has a higher electric potential with respect to a positive electrode active material in comparison with the negative electrode active material contained in the liquid retaining part and contains the negative electrode active material whose expansion and contraction rate according to increase and decrease of a SOC is large. That publication describes that it is possible, by the configuration described above, to properly inhibit a shortage of the nonaqueous electrolytic solution at the inside of the electrode assembly, so as to maintain a battery performance of the nonaqueous electrolytic solution secondary battery being in a suitable state.

An electrode disclosed by Japanese Patent Application Publication No. 2023-100057 includes a base material, and an active material layer arranged on a surface of the base material. On a surface of the active material layer, 1 or more grooves are formed. The grooves are configured to extend in a line shape along the surface of the active material layer, and to include an inlet area, a middle area, and an outlet area in a plane view. The inlet area includes an inlet opening part at a peripheral edge of the active material layer. The outlet area includes an outlet opening part at the peripheral edge of the active material layer. The middle area is arranged between the inlet area and the outlet area and connects the inlet area and the outlet area. Each of the inlet area and the outlet area is configured to make a first pressure loss at a time of flowing a fluid in a forward direction be smaller than a second pressure loss at a time of flowing a fluid in a backward direction. The forward direction represents a direction toward the outlet area from the inlet area, and the backward direction represents a direction toward the inlet area from the outlet area. That publication describes that, by the configuration described above, a directivity is caused on a flow of the electrolytic solution in the groove of the electrode, and thus it becomes easy to exhaust a bubble.

### SUMMARY

The present inventor thinks to implement not inhibiting an intrusion of the electrolytic solution from the outside of the electrode assembly to the inside of the electrode assembly, but suppressing the electrolytic solution from outflowing from the inside to the outside of the electrode assembly.

According to the herein disclosed technique, an electric storage device is disclosed that includes an electrode assembly including a positive electrode, a negative electrode, and a separator, includes an electrolytic solution, and includes a case configured to accommodate the electrode assembly and the electrolytic solution. The electric storage device includes a reverse flow inhibiting groove on a surface of the separator. The reverse flow inhibiting groove is a groove in which the electrolytic solution flows from the outside to the inside of the electrode assembly, and is a groove which is formed in a pattern for inhibiting a fluid of the electrolytic solution flowing from the inside to the outside of the electrode assembly. In accordance with such a configuration, it is possible to implement not inhibiting an intrusion of the electrolytic solution from the outside of the electrode assembly to the inside of the electrode assembly, but suppressing the electrolytic solution from outflowing to the outside from the inside of the electrode assembly.

According to the herein disclosed technique, a separator is disclosed that is used for an electric storage device which includes an electrode assembly including a positive electrode, a negative electrode, and a separator, which includes an electrolytic solution, and which includes a case configured to accommodate the electrode assembly and the electrolytic solution. The separator includes a reverse flow inhibiting groove on a surface. The reverse flow inhibiting groove is a groove in which the electrolytic solution flows from the outside to the inside of the electrode assembly, and is a groove which is formed in a pattern for inhibiting the fluid of the electrolytic solution flowing from the inside to the outside of the electrode assembly. In accordance with such a configuration, it is possible to implement not inhibiting an intrusion of the electrolytic solution from the outside of the electrode assembly to the inside of the electrode assembly, but suppressing the electrolytic solution from outflowing to the outside from the inside of the electrode assembly.

### BRIEF DESCRIPTION OF THE DRAWINGS

FIG. 1 is a perspective view that schematically shows a battery 1.

FIG. 2 is a II-II cross section view of FIG. 1.

FIG. 3 is a perspective view that shows an electrode assembly 20 attached to a sealing plate 14.

FIG. 4 is a perspective view that shows an electrode assembly 20 on which a second electrical collector part 52 is attached.

FIG. 5 is a schematic view of the electrode assembly 20.

FIG. 6 is a plane view of a separator 26.

FIG. 7 is an explanation view of a shape of a reverse flow inhibiting groove 27.

FIG. 8 is a IIX-IIX cross section view of FIG. 6.

FIG. 9 is a plane view of a separator 226.

FIG. 10 is a schematic view of an electrode assembly 320.

FIG. 11 is a perspective view of an electrode assembly 420.

### DESCRIPTION OF THE EMBODIMENTS

Below, an embodiment of a herein disclosed technique would be explained. The embodiment explained herein is not intended to particularly restrict the herein disclosed technique. The herein disclosed technique is not restricted to the embodiment explained herein, unless specifically mentioned. Drawings are schematically shown, and thus might not always reflect a real product. The members/parts providing the same effect are suitably provided with the same numerals and signs, and overlapping explanations might be omitted. In the drawings, reference signs of “F”, “Rr”, “R”, “L”, “U”, and “D” respectively show front, rear, right, left, up, and down. A wording “A to B” representing a numerical value range is to mean, unless specifically mentioned, “equal to or more than A and not more than B” and in addition, is to semantically cover a meaning of “more than A and less than B”.

In the present specification, a wording “electric storage device” means a device that generates an electric charge and discharge by moving a charge carrier between a pair of electrodes (a positive electrode and a negative electrode) through an electrolyte. The electric storage device described above semantically covers a secondary battery, such as lithium ion secondary battery, nickel hydrogen battery, and nickel cadmium battery, and a capacitor, such as lithium ion capacitor, and electric double layer capacitor. Below, as an example of the above described electric storage device, an embodiment in a case where the lithium ion secondary battery is set to be an object will be described. Thus, the electric storage device explained below might be simply referred to as “battery”.

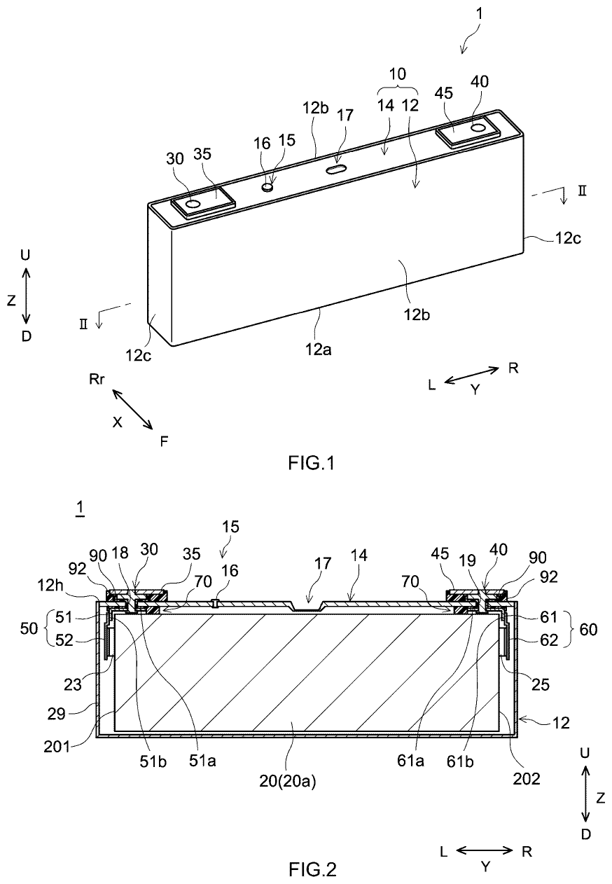

FIG. 1 is a perspective view that schematically shows a battery 1. FIG. 2 is a II-II cross section view of FIG. 1. As shown in FIG. 1 and FIG. 2, the battery 1 includes a case 10, an electrode assembly 20, a positive electrode terminal 30, a negative electrode terminal 40, outside conductive members 35, 45, a positive electrode collecting member 50, a negative electrode collecting member 60, an insulator 70, a gasket 90, and an outside insulating member 92. Although omitted in drawings, the battery 1 includes, for example, an electrolytic solution. As the electrolytic solution, it is possible to use an electrolytic solution used as an electrolytic solution of this kind of lithium ion secondary battery, without particular restriction. A composition of the electrolytic solution described above is not to characterize the herein disclosed technique, and thus a detailed explanation herein is omitted.

The case 10 in this embodiment is a housing configured to accommodate the electrode assembly 20 and the electrolytic solution at the inside. The case 10 herein has an outer appearance that is formed in a flat and bottomed rectangular parallelepiped shape (a square shape). A material of the case 10 might be the same as a material conventionally used, and is not particularly restricted. It is preferable that the case 10 is made of a metal, and it is further preferable that the case is, for example, made from aluminum, aluminum alloy, iron, iron alloy, or the like.

The case 10 in this embodiment includes an outer case 12 and a sealing plate (a cover) 14. The outer case 12 includes, as shown in FIG. 1, a bottom part 12a formed in a flat surface rectangular shape, a pair of first side walls 12b extending in a vertical direction Z from a pair of opposed sides of the bottom part 12a and being opposed mutually, and a pair of second side walls 12c extending in the vertical direction Z from a pair of opposed sides of the bottom part 12a and being opposed mutually. In this embodiment, the first side walls 12b are longer side walls extending from a pair of long opposed sides of the bottom part 12a. The second side walls 12c are shorter side walls extending from a pair of short opposed sides of the bottom part 12a. In this embodiment, an area size of the second side wall 12c is smaller than an area size in of the first side wall 12b. A portion being opposed to the bottom part 12a and being surrounded by the pair of first side walls 12b and the pair of second side walls 12c is an opening part 12h. The sealing plate 14 is a member configured to seal the opening part 12h of the outer case 12. The sealing plate 14 is opposed to the bottom part 12a of the outer case 12. The sealing plate 14 is approximately rectangular in a plane view. The case 10 is integrated by making the sealing plate 14 be joined to a peripheral edge of the opening part of the outer case 12. A joining means is a welding, such as laser welding, for example. The case 10 is airtightly sealed (hermetically sealed).

The sealing plate 14 is provided with a liquid injection hole 15 and a gas exhausting valve 17. The liquid injection hole 15 is for injecting the electrolytic solution after the sealing plate 14 is assembled to the outer case 12. The liquid injection hole 15 is sealed by a sealing member 16. The gas exhausting valve 17 is a thin-walled part that is configured to be broken when a pressure inside the case 10 becomes equal to or more than a predetermined value, so as to exhaust the gas inside the case 10 to the outside.

In this embodiment, the positive electrode terminal 30 and the negative electrode terminal 40 are attached to the sealing plate 14. In this embodiment, the positive electrode terminal 30 is arranged at one of end parts (a left end part of FIG. 1 and FIG. 2) in a long side direction Y of the sealing plate 14. In this embodiment, the negative electrode terminal 40 is arranged at the other end part (a right end part of FIG. 1 and FIG. 2) in the long side direction Y of the sealing plate 14.

The positive electrode terminal 30 is, as shown in FIG. 2, electrically connected to a positive electrode 22 of the electrode assembly 20 through the positive electrode collecting member 50 at the inside of the outer case 12 (see FIG. 5). The positive electrode terminal 30 is, for example, inserted into a terminal taking out hole 18 and then pulled out from the inside to the outside of the sealing plate 14. The positive electrode terminal 30 is insulated from the sealing plate 14 by the insulator 70 and the gasket 90. It is preferable that the positive electrode terminal 30 is made of metal, and it is more preferable that the positive electrode terminal is made from, for example, aluminum or aluminum alloy. On the positive electrode terminal 30, the outside conductive member 35 is fixed. The positive electrode terminal 30 is joined to the outside conductive member 35.

The negative electrode terminal 40 is, as shown in FIG. 2, electrically connected to the negative electrode 24 of the electrode assembly 20 through the negative electrode collecting member 60 at the inside of the outer case 12 (see FIG. 5). The negative electrode terminal 40 is, for example, inserted into a terminal taking out hole 19 and pulled out from the inside to the outside of the sealing plate 14. The negative electrode terminal 40 is insulated from the sealing plate 14 by the insulator 70 and the gasket 90. It is preferable that the negative electrode terminal 40 is made of metal, and it is more preferable that the negative electrode terminal is made from, for example, copper or copper alloy. On the negative electrode terminal 40, the outside conductive member 45 is fixed. The negative electrode terminal 40 is joined to the outside conductive member 45.

The positive electrode collecting member 50 is, for example, a member configured to electrically connect the positive electrode 22 and the positive electrode terminal 30 at the inside of the outer case 12. As shown in FIG. 2, the positive electrode collecting member 50 includes a first electrical collector part 51 and a second electrical collector part 52. The first electrical collector part 51 is, for example, formed in a cross section letter “L” shape. The first electrical collector part 51 includes, for example, a base 51a and a lead 51b. As shown in FIG. 2, the base 51a is arranged along a surface at an inner side of the sealing plate 14. The lead 51b is, for example, configured to extend from one of end parts in a width direction Y of the base 51a toward the bottom part 12a (see FIG. 1). To the lead 51b, for example, the second electrical collector part 52 is connected.

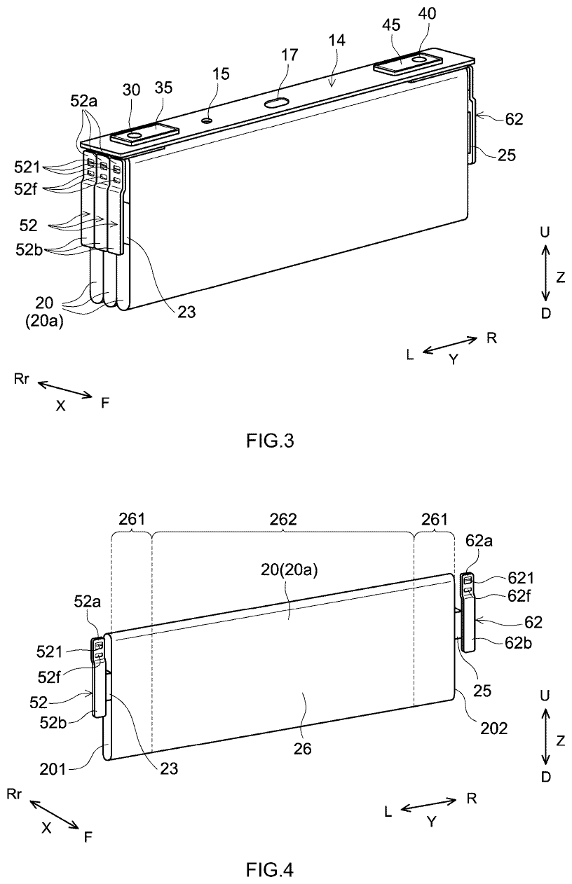

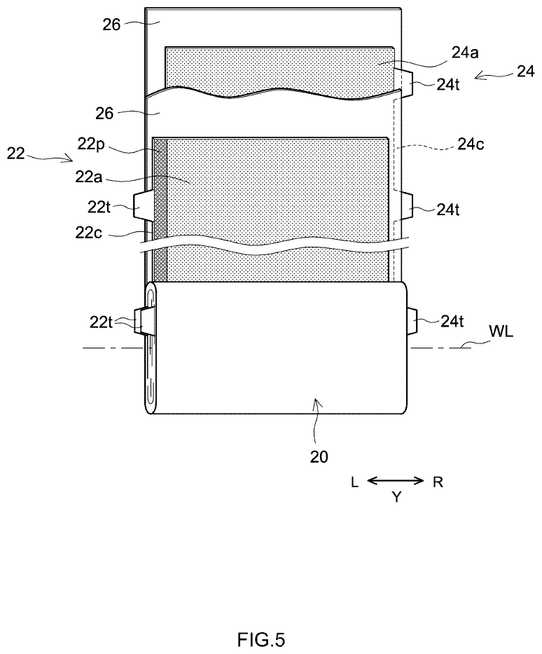

FIG. 3 is a perspective view that shows the electrode assembly 20 attached to the sealing plate 14. FIG. 4 is a perspective view that shows the electrode assembly 20 to which the second electrical collector part 52 is attached. As shown in FIGS. 1 to 4, the second electrical collector part 52 extends toward the bottom part 12a of the outer case 12. In this embodiment, the second electrical collector part 52 includes a first connection piece 52a and a second connection piece 52b. The first connection piece 52a is, for example, a portion electrically connected to the first electrical collector part 51. In this embodiment, the first connection piece 52a is connected to the first electrical collector part 51 through a connecting portion 521. The connecting portion 521 is, for example, a thin-walled part. The first connection piece 52a is, for example, configured to extend along a vertical direction Z. The first connection piece 52a is, in this embodiment, arranged almost vertically to a winding axis WL of each electrode assembly 20. Although not particularly restricting, a fuse part 52f might be formed on the first connection piece 52a. The fuse part 52f is configured to melt down when a current equal to or more than 1000 A (for example, a short circuit current) flows in the battery 1.

The second connection piece 52b is, for example, a portion joined to the positive electrode tab group 23. In this embodiment, the second connection piece 52b is configured to extend along the vertical direction Z. The second connection piece 52b is arranged almost vertically to the winding axis WL of each electrode assembly 20. A surface connected to plural positive electrode tabs 22t of the second connection piece 52b is arranged almost parallel to the second side wall 12c of the outer case 12. From a perspective of sufficiently securing a width of the second connection piece 52b and additionally decreasing the battery resistance of the battery 1, the surface connected to the plural positive electrode tabs 22t of the second connection piece 52b (see FIG. 5) is arranged to be opposed to a first end part 201 of the electrode assembly 20.

The negative electrode collecting member 60 is a member configured to electrically connect the negative electrode 24 and the negative electrode terminal 40 at the inside of the outer case 12. The negative electrode collecting member 60 includes, as shown in FIGS. 2 to 4, a first electrical collector part 61 and a second electrical collector part 62. The first electrical collector part 61 includes a base 61a and a lead 61b. The second electrical collector part 62 includes a first connection piece 62a and a second connection piece 62b. A configuration of the negative electrode collecting member 60 is similar to the configuration of the above described positive electrode collecting member 50, and thus a detailed explanation herein is omitted. Incidentally, regarding the negative electrode collecting member 60, a reference sign “621” in FIG. 4 indicates a connecting portion and a reference sign “62f” indicates a fuse part.

As shown in FIG. 3, the battery 1 includes three electrode assemblies 20. As shown in FIG. 3 and FIG. 4, the second electrical collector part 52 of the positive electrode collecting member 50 is arranged at one side (a left side of FIG. 3 and FIG. 4) in the long side direction Y, the second electrical collector part 62 of the negative electrode collecting member 60 is arranged at the other side in the long side direction Y (a right side of FIG. 3 and FIG. 4), and they are connected in parallel. As shown in FIG. 2, one or plural electrode assemblies 20 are arranged inside the outer package 12, in a state of being covered by an electrode assembly holder 29 that consists of a sheet made of resin, such as polypropylene (PP). Incidentally, a number of the electrode assemblies 20 accommodated by the battery 1 is not particularly restricted, and it might be, for example, 1, 2, or equal to or more than 4.

FIG. 5 is a schematic view of the electrode assembly 20. As shown in FIG. 5, the electrode assembly 20 includes the positive electrode 22, the negative electrode 24, and the separator 26 configured to insulate the positive electrode 22 and the negative electrode 24. As shown in FIG. 5, the electrode assembly 20 is an electrode assembly (a wound electrode assembly) in which the positive electrode 22 and the negative electrode 24 are laminated via the separator 26 and then wound therein so as to be manufactured.

As shown in FIG. 2 to FIG. 4, the electrode assembly 20 includes a body 20a, a positive electrode tab group 23, and a negative electrode tab group 25. The body 20a is a portion in which the positive electrode 22, the negative electrode 24, and the separator 26 are laminated, and is formed in a flat shape, for example. A width of the body 20a is, for example, equal to or more than 10 cm. The width of the body 20a might be, for example, equal to or more than 15 cm, or might be equal to or more than 20 cm. The width of the body 20a might be, for example, equal to or less than 50 cm, or might be equal to or less than 40 cm. In the present specification, a wording “width of the body 20a” represents, for example, a length of the body 20a in a shorter direction of the positive electrode 22 and negative electrode 24 (the width direction Y along a winding axis direction in FIG. 5).

As shown in FIG. 1, FIG. 2, and FIG. 5, the electrode assembly 20 is arranged inside the outer package 12 in a direction which makes the winding axis WL be in parallel to the width direction Y. In this embodiment, the electrode assembly 20 is arranged inside the outer package 12 in a direction which makes the winding axis WL be in parallel to the bottom part 12a and be orthogonal to the second side wall 12c. Then, both ends of the electrode assembly 20 in a direction along the winding axis WL (below, which is referred to as “winding axis direction”, too) are opposed to the second side walls 12c of the outer case 12. In the present specification, an end part of the electrode assembly 20 (for example, the body 20a) opposed to the second side wall 12c at a side closer to the positive electrode collecting member 50 (a left side in the width direction Y of FIG. 2 and FIG. 4) is referred to as “first end part 201”. An end part of the electrode assembly 20 (for example, the body 20a) opposed to the second side wall 12c at a side closer to the negative electrode collecting member 60 (a right side in the width direction Y of FIG. 2 and FIG. 4) is referred to as “second end part 202”. In this embodiment, the first end part 201 and second end part 202 of the electrode assembly 20 are laminate surfaces (open surfaces) configured with the positive electrode 22, the negative electrode 24, and the separator 26, and are opened to the outside of the electrode assembly 20. At the first end part 201 and the second end part 202, for example, the electrolytic solution flows in or flows out.

The positive electrode 22 includes, for example, a positive electrode collecting foil 22c (for example, an aluminum foil) formed in a long strip-like shape, and a positive electrode active material layer 22a fixed on at least one surface of the positive electrode collecting foil 22c. Although not particularly restricting, one of side edge parts in the width direction Y of the positive electrode 22 is provided with a protective layer 22p, as needed. Incidentally, as a material for configuring the positive electrode active material layer 22a and a material for configuring the protective layer 22p, ones used for this kind of the battery (in this embodiment, the lithium ion secondary battery) can be used without particular restriction.

At one of end parts (a left end part of FIG. 5) in the width direction Y of the positive electrode collecting foil 22c, plural positive electrode tabs 22t are provided. Each of the plural positive electrode tabs 22t is configured to protrude toward one side (a left side of FIG. 5) in the width direction Y. The plural positive electrode tabs 22t are provided at intervals (intermittently) along a longitudinal direction of the positive electrode 22. The positive electrode tab 22t is a part of the positive electrode collecting foil 22c, and is a portion where neither the positive electrode active material layer 22a nor the protective layer 22p of the positive electrode collecting foil 22c is formed (a collecting foil exposed part). In this embodiment, the plural positive electrode tabs 22t are configured to protrude in the width direction Y more than the separator 26. For example, the plural positive electrode tabs 22t are laminated at one of the end parts (the left end part of FIG. 5) in the width direction Y, so as to configure a positive electrode tab group 23 (see FIG. 2 to FIG. 4). As shown in FIG. 2, the positive electrode collecting member 50 is joined to the positive electrode tab group 23. As shown in FIG. 1 to FIG. 3, the positive electrode tab group 23 joined to the positive electrode collecting member 50 is folded and bent to make tip ends of the plural positive electrode tabs 22t configuring the positive electrode tab group 23 be arranged along the second side wall 12c. Incidentally, in FIG. 5, the positive electrode tabs 22t are shown in which respective lengths and shapes are approximately the same, but respective lengths and shapes of the positive electrode tabs 22t might be different.

The negative electrode 24 includes, for example, a negative electrode collecting foil 24c (for example, a copper foil) formed in a long strip-like shape, and a negative electrode active material layer 24a fixed on at least one surface of the negative electrode collecting foil 24c. Incidentally, as a material for configuring the negative electrode active material layer 24a, it is possible to use one used for this kind of battery (in this embodiment, the lithium ion secondary battery) without particular restriction.

At one of end parts (a right end part of FIG. 5) in the width direction Y of the negative electrode collecting foil 24c, plural negative electrode tabs 24t are provided. The plural negative electrode tabs 24t are configured to protrude toward one side (a right side of FIG. 5) in the width direction Y. The plural negative electrode tabs 24t are provided at intervals (intermittently) along a longitudinal direction of the negative electrode 24. The negative electrode tab 24t herein is a part of the negative electrode collecting foil 24c, and is a portion where the negative electrode active material layer 24a of the negative electrode collecting foil 24c is not formed (a collecting foil exposed part). In this embodiment, the negative electrode tab 24t is configured to protrude in the width direction Y more than the separator 26. For example, the plural negative electrode tabs 24t are laminated at one end part (the right end part of FIG. 5) in the width direction Y, so as to configure the negative electrode tab group 25 (see FIG. 2 to FIG. 4). As shown in FIG. 2, the negative electrode collecting member 60 is joined to the negative electrode tab group 25. The negative electrode tab group 25 joined to the negative electrode collecting member 60 is folded and bent to make tip ends of the plural negative electrode tabs 24t configuring the negative electrode tab group 25 be arranged along the second side wall 12c. Incidentally, in FIG. 5, the negative electrode tabs 24t are shown in which respective lengths and shapes are approximately the same, but the lengths and shapes of respective negative electrode tabs 24t might be different.

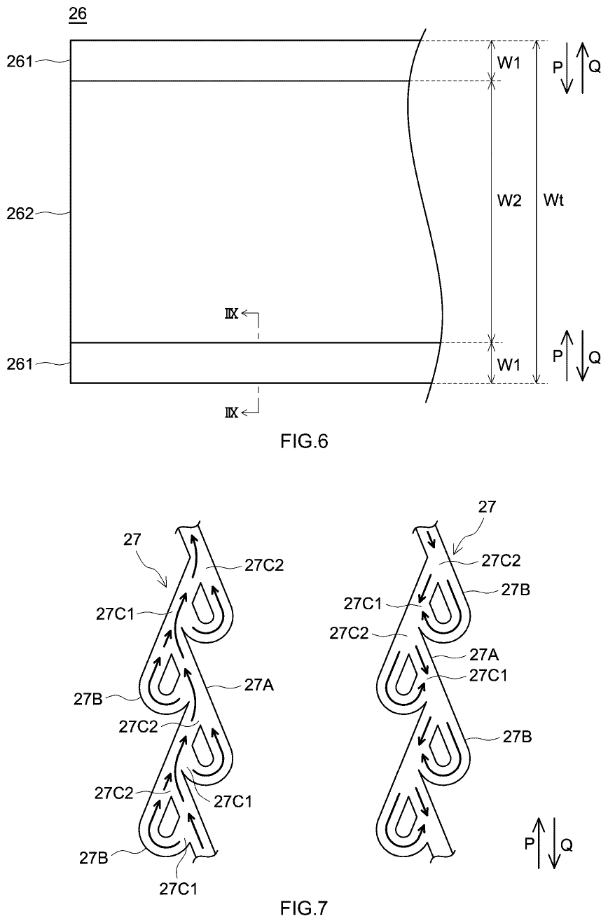

FIG. 6 is a plane view of the separator 26. The separator 26 is a member configured to insulate the positive electrode active material layer 22a of the positive electrode 22 from the negative electrode active material layer 24a of the negative electrode 24. The separator 26 configures an outer surface of the electrode assembly 20. In this embodiment, as shown in FIG. 5 and FIG. 6, the separator 26 is a separator sheet formed in a long strip-like shape. A width of the separator 26 (a length in the width direction Y along the winding axis direction) is larger than a length of the positive electrode 22 in the same direction from which the positive electrode tab 22t is excluded, and is larger than a length of the negative electrode 24 in the same direction from which the negative electrode tab 24t is excluded.

FIG. 7 is an explanation view of a shape of a reverse flow inhibiting groove 27. In FIG. 7, a flat surface shape of the reverse flow inhibiting groove 27 is partially shown. The separator 26 herein includes the reverse flow inhibiting groove 27 (see FIG. 6 and FIG. 7). The reverse flow inhibiting groove 27 herein is a groove formed on a surface of the separator 26 for flowing the electrolytic solution from the outside to the inside of the electrode assembly 20, and formed in a pattern of inhibiting the electrolytic solution from flowing to the outside from the inside of the electrode assembly 20. In this embodiment, the reverse flow inhibiting groove 27 is further a flow channel for the electrolytic solution flowing from the outside to the inside of the electrode assembly 20, and is furthermore a flow channel for the electrolytic solution flowing from the inside to the outside of the electrode assembly 20. However, the reverse flow inhibiting groove 27 is configured to make the electrolytic solution flow with relative ease in the direction from the outside to the inside of the electrode assembly 20, and configured to make the electrolytic solution flow with relative difficulty in the direction from the inside to the outside of the electrode assembly 20. Incidentally, in an explanation described below, the direction from the outside to the inside of the electrode assembly 20 might be referred to as a first direction P, and the direction from the inside to the outside of the electrode assembly 20 might be referred to as a second direction Q (see FIG. 6 and FIG. 7).

Regarding a form shown by FIG. 7, the reverse flow inhibiting groove 27 is provided in a Tesla valve shape. As shown in FIG. 7, the reverse flow inhibiting groove 27 includes a main pipe 27A and a sub pipe 27B formed in a loop shape. The main pipe 27A configures, for example, a flow channel in which the electrolytic solution flows from the outside to the inside of the electrode assembly 20, and a flow channel in which the electrolytic solution flows from the inside to the outside of the electrode assembly 20. The sub pipe 27B is, for example, a pipe that branches from the main pipe 27A and then is merged to the main pipe 28A after the branch from the main pipe 27A. As shown in FIG. 7, plural sub pipes 27B are coupled to the main pipe 27A. In a form shown by FIG. 7, each of the sub pipes 27B is coupled at two positions to the main pipe 27A. The main pipe 27A and the sub pipe 27B are coupled at two positions being a first coupling portion 27C1 and a second coupling portion 27C2. The first coupling portion 27C1 is arranged at a relatively outer side of the electrode assembly 20, among two coupling portions of the main pipe 27A and sub pipe 27B. The second coupling portion 27C2 is arranged at a relatively inner side of the electrode assembly 20, among the two coupling portions of the main pipe 27A and sub pipe 27B.

In this embodiment, when the electrolytic solution flows in the first direction P (see the reverse flow inhibiting groove 27 at a left side of FIG. 7), the electrolytic solution flowing in the main pipe 27A dividedly flows from the main pipe 27A to the sub pipe 27B at the first coupling portion 27C1, but it is difficult to inhibit the flow in the direction P because a dividedly flowing amount of the electrolytic solution to the sub pipe 27B structurally becomes smaller relatively in comparison to the main pipe 27A. At the second coupling portion 27C2, the electrolytic solution flowing in the sub pipe 27B is also merged into the electrolytic solution flowing in the main pipe 27A along a direction in which the electrolytic solution flowing in the main pipe 27A flows (here, the first direction P), and thus it does not inhibit the flow in the direction P. In contrary, when the electrolytic solution flows in the second direction Q (see the reverse flow inhibiting groove 27 at the right side of FIG. 7), at the second coupling portion 27C2, the electrolytic solution flowing in the main pipe 27A dividedly flows from the main pipe 27A to the sub pipe 27B, but it is easy to inhibit the flow in the direction Q because the dividedly flowing amount of the electrolytic solution to the sub pipe 27B structurally becomes larger relatively in comparison to the main pipe 27A. At the first coupling portion 27C1, the electrolytic solution flowing in the sub pipe 27B is merged, from a backward direction with respect to a direction (here, the second direction Q) in which the electrolytic solution flowing in the main pipe 27A flows, into the electrolytic solution flowing in the main pipe 27A, and thus it inhibits the flow of the electrolytic solution in the main pipe A to the direction Q.

As shown in FIG. 4 and FIG. 6, the separator 26 includes first areas 261 and a second area 262. The first areas 261 are, for example, areas which are opened to the outside of the electrode assembly 20 at edge parts of the separator 26. Here, the wording “areas which are opened to the outside of the electrode assembly 20” represents areas where it is possible to implement an inflow of the electrolytic solution from the outside of the electrode assembly 20 and implement an outflow of the electrolytic solution to the inside of the electrode assembly 20. In a form shown by FIG. 4, the first areas 261 are respectively positioned adjacent to the first end part 201 and second end part 202 of the electrode assembly 20 on the separator 26. In a form shown by FIG. 6, the first areas 261 are areas provided at both ends in the shorter direction of the separator 26 and formed in strip-like shapes along the longitudinal direction of the separator 26. The second area 262 is, for example, an area of the separator 26 from which the first areas 261 are excluded. In the form shown by FIG. 4, the second area 262 is sandwiched between the first areas 261. In the form shown by FIG. 6, the second area 262 is an area which is sandwiched by the first areas 261 and further which is formed in a strip-like shape along the longitudinal direction of the separator 26.

Although not particularly restricting, a ratio (W1/Wt) regarding a width W1 of the first area 261 (one side) and a width Wt of the separator 26 in FIG. 6 is approximately ⅛ to ½, or preferably ¼ to ⅓. A ratio (W2/Wt) with respect to a width W2 of the second area 262 and the width Wt of the separator 26 is approximately equal to or less than ¾, or preferably ⅓ to ½.

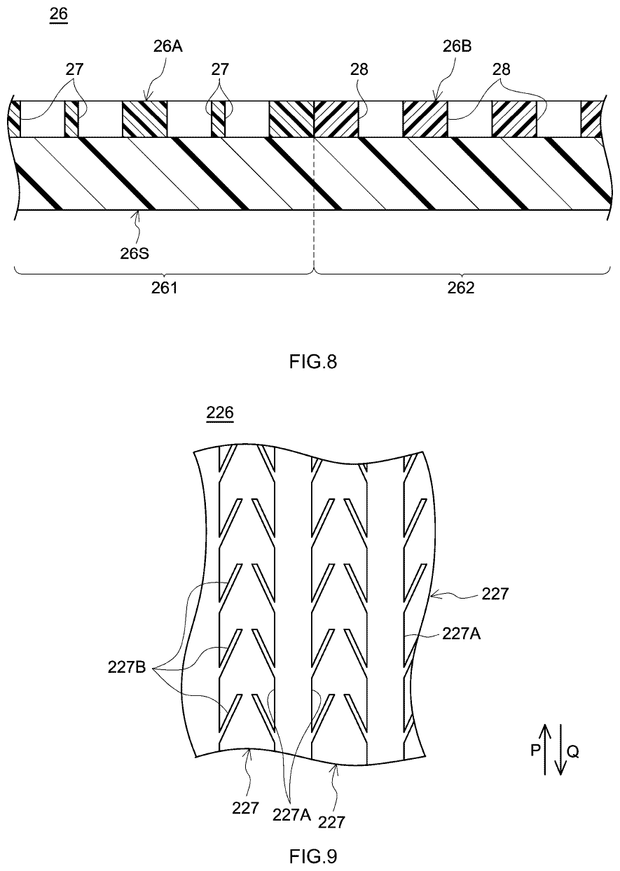

In this embodiment, the reverse flow inhibiting groove 27 is provided on the first area 261. It is good that the reverse flow inhibiting groove 27 is, for example, provided on the first area 261 so as to make the main pipe 27A be arranged along the shorter direction of the separator 26. In this embodiment, on the second area 262, a groove 28 having a pattern different from the reverse flow inhibiting groove (see FIG. 8) is provided. As the pattern of the groove 28 provided on the second area 262, although not particularly restricted, it is possible to use, for example, a dot shape, a stripe shape along the shorter direction of the separator 26, a stripe shape along the longitudinal direction of the separator 26, or the like.

FIG. 8 is an IIX-IIX cross section view of FIG. 6. In FIG. 8, a cross section structure of the first area 261 and second area 262 of the separator 26 is partially shown. As shown in FIG. 8, the separator 26 includes a base material 26S, a first layer 26A, and a second layer 26B. As the base material 26S, it is possible to use a conventionally known porous sheet used as a separator for this kind of battery, without particular restriction. The base material 26S might have a single-layer structure, or might have a multi-layer structure including 2 or more layers (for example, 3-layer structure). It is preferable that the base material 26S is, for example, a porous sheet made from a polyolefin, such as polyethylene (PE) and polypropylene (PP).

As shown in FIG. 8, the first layer 26A is provided on a surface of the base material 26S. In this embodiment, the first layer 26A is provided on a first area 261. In the form shown by FIG. 8, the reverse flow inhibiting groove 27 is provided on the first layer 26A. As shown in FIG. 8, the second layer 26B is provided on the surface of the base material 26S. In this embodiment, the second layer 26B is provided on the second area 262. In the form shown by FIG. 8, the groove 28 is provided on the second layer 26B.

In this embodiment, the first layer 26A and the second layer 26B are adhesion layers. The adhesion layer is, for example, a layer configured with an adhesive agent. As the adhesive agent, it is possible to use, for example, an acrylic resin; a rubber type resin such as styrene butadiene rubber (SBR); a fluorine type resin such as polyvinylidene fluoride (PVdF) and polytetrafluoroethylene (PTFE); or the like; an urethane type resin; a silicone type resin; an epoxy type resin; or the like. Regarding the resin, 1 kind might be used singly, or 2 or more kinds might be combined so as to be used. From a perspective of implementing a superior flexibility and enhancing an adhesive property with respect to an electrode, the fluorine type resin, the acrylic resin, or the like, are preferably used as the adhesive agent. The adhesive agent configuring the first layer 26A and the adhesive agent configuring the second layer 26B might be the same or might be different from each other.

A method for forming the first layer 26A including the reverse flow inhibiting groove 27 is not particularly restricted, and it is possible to use a conventionally known method. As the method for forming the first layer 26A, it is possible, for example, to use an ink jet print. In this case, a slurry configured by mixing the above described adhesive agent and a solvent or dispersion medium (for example, a water type solvent, or an organic solvent) for forming the first layer 26A is applied to coat the base material 26S in a predetermined pattern. Then, by drying this coating film, it is possible to form the first layer 26A including the reverse flow inhibiting groove 27. A method for forming the second layer 26B including the groove 28 might be the same as the above described one, except for forming the groove 28 instead of the reverse flow inhibiting groove 27.

The electrolytic solution includes, for example, an electrolyte salt and a nonaqueous solvent. As the electrolyte salt, it is possible to use, for example, LiPF₆, or the like. A concentration of the electrolyte salt in the electrolytic solution is for example, 0.7 mol/L to 1.3 mol/L. The nonaqueous solvent might be, for example, carbonates. As the carbonates, it is possible to use, for example, ethylene carbonate (EC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), trifluoro dimethyl carbonate (TFDMC), or the like. Regarding them, it is possible to use single one or a combination of 2 or more kinds.

The battery 1 can be used for various purposes, but among them, it is preferably used as a power source for a motor (a power supply for driving) mounted on a vehicle, such as passenger car and truck. The type of the vehicle is not particularly restricted, but as a suitable instance, it is possible to be, for example, a plug-in hybrid electric vehicle (PHEV), a hybrid electric vehicle (HEV), a battery electric vehicle (BEV), or the like.

As described above, the battery 1 includes the electrode assembly 20, including the positive electrode 22, the negative electrode 24, and the separator 26 establishing an insulation between the positive electrode 22 and the negative electrode 24, includes the electrolytic solution, and includes the case 10 configured to accommodate the electrode assembly 20 and the electrolytic solution. The battery 1 includes the reverse flow inhibiting groove 27 on the surface of the separator 26. The reverse flow inhibiting groove 27 is a groove in which the electrolytic solution flows from the outside to the inside of the electrode assembly 20, and is formed in a pattern for inhibiting the electrolytic solution from flowing to the outside from the inside of the electrode assembly 20.

As described above, the reverse flow inhibiting groove 27 is the groove in which the electrolytic solution flows from the outside to the inside of the electrode assembly 20, but is also the groove for inhibiting the electrolytic solution from flowing to the outside from the inside of the electrode assembly 20. In other words, the reverse flow inhibiting groove 27 promotes the electrolytic solution impregnating into the electrode assembly 20, and further suppresses the outflow of the electrolytic solution from the electrode assembly 20. By including the separator 26 provided with the reverse flow inhibiting groove 27, in the battery 1, without inhibiting the intrusion of the electrolytic solution from the outside of the electrode assembly 20 to the inside of the electrode assembly 20, it is possible to suppress the outflow of the electrolytic solution from the inside to the outside of the electrode assembly 20. By this, it is possible to enhance an uniformity of distribution of the electrolytic solution in the electrode assembly 20.

The battery 1 might include, at the edge part of the separator 26, the reverse flow inhibiting groove 27 on the first area 261 which is opened to the outside of the electrode assembly 20. In other words, the separator 26 might include the reverse flow inhibiting groove 27 on the first area 261 configuring the edge part. The first area 261 is, for example, an area of the electrode assembly 20 in which the inflow and the outflow of the electrolytic solution into and from the electrode assembly 20 occur. By providing the reverse flow inhibiting groove 27 on the first area 261, it is possible to further suitably suppress the electrolytic solution inflowing (impregnating) into the electrode assembly 20 from outflowing (reverse-flowing) to the outside of the electrode assembly 20.

The separator 26 might include the base material 26S and the first layer 26A on the surface of the base material 26S. The first layer 26A might be provided on the first area 261. The reverse flow inhibiting groove 27 might be provided on the first layer 26A. By including the first layer 26A where the reverse flow inhibiting groove 27 is provided on the first area 261, it is possible onto the separator 26 to impart not only an outflow inhibiting effect of the electrolytic solution, but also another effect (for example, an adhesion effect).

The separator 26 might include the second area 262 from which the first area 261 is excluded. On the surface of the base material 26S regarding the second area 262, a second layer 26B might be provided. On the second layer 26B, the groove 28 having a pattern different from the reverse flow inhibiting groove 27 might be provided. By providing the groove 28 on the second area 262 which has a pattern different from the reverse flow inhibiting groove 27, it becomes easy to hold the electrolytic solution on the second area 262. By this, it is possible to enhance the uniformity of the distribution of the electrolytic solution in the electrode assembly 20. In addition to this, by providing the groove structures on the first area 261 and the second area 262, it is possible to enhance the uniformity of the thickness of the electrode assembly 20.

The battery 1 might include a wound electrode assembly, as the electrode assembly 20, in which the positive electrode 22 formed in a long sheet shape and the negative electrode 24 formed in a long sheet shape are laminated via the separator 26 formed in a long sheet shape and then are wound in the sheet longitudinal direction. On the wound electrode assembly, for example, in comparison to the laminate electrode assembly, an ununiformity of the distribution of the electrolytic solution tends to be easily caused. By using the separator 26 having the above described configuration for the electrode assembly 20 being the wound electrode assembly, it is possible to further suitably implement the effect of the herein disclosed technique.

The reverse flow inhibiting groove 27 might include the main pipe 27A and the sub pipe 27B that is formed in a loop shape to couple to the main pipe 27A at two positions. The main pipe 27A might configure a flow channel in which the electrolytic solution flows from the outside to the inside of the electrode assembly 20, and a flow channel in which the electrolytic solution flows from the inside to the outside of the electrode assembly 20. It is good that the reverse flow inhibiting groove 27 is configured as described below, for a case where the electrolytic solution flows from the outside to the inside of the electrode assembly 20 and for a case where the electrolytic solution flows from the inside to the outside of the electrode assembly 20. In the case where the electrolytic solution flows from the outside to the inside of the electrode assembly 20, on the first coupling portion 27C1 arranged at a relatively outer side of the electrode assembly 20 among the two coupling portions 27C1, 27C2 with respect to the main pipe 27A and the sub pipe 27B, the electrolytic solution flowing in the main pipe 27A might dividedly flows from the main pipe 27A to the sub pipe 27B. At that time, on the second coupling portion 27C2 arranged at a relatively inner side of the electrode assembly 20 among the two coupling portions 27C1, 27C2 with respect to the main pipe 27A and the sub pipe 27B, the electrolytic solution flowing in the sub pipe 27B might be merged into the electrolytic solution flowing in the main pipe 27A along a flowing direction (here, the first direction P) of the electrolytic solution flowing in the main pipe 27A. In the case where the electrolytic solution flows from the inside to the outside of the electrode assembly 20, on the second coupling portion 27C2, the electrolytic solution flowing in the main pipe 27A might dividedly flows from the main pipe 27A to the sub pipe 27B. It is good at the first coupling portion 27C1 that the electrolytic solution flowing in the sub pipe 27B is merged into the electrolytic solution flowing in the main pipe 27A, from a backward direction with respect to the flowing direction of the electrolytic solution flowing in the main pipe 27A (here, the second direction Q). The above described configuration of the reverse flow inhibiting groove 27 is preferable for implementing the effect of the herein disclosed technique.

The reverse flow inhibiting groove 27 might be provided in a Tesla valve shape. The above described configuration of the reverse flow inhibiting groove 27 is preferable for implementing the effect of the herein disclosed technique.

Above, an embodiment of the herein disclosed technique has been explained, but it is merely an illustration, and thus it is not intended to restrict the scope of claims. The technique recited in claims contains ones in which the above described embodiment is variously deformed or changed. Below, another embodiment of the herein disclosed technique will be described. Incidentally, except for the above described matter of the below described embodiment, it is similar to explanation about the above described embodiment. Thus, the overlapping explanation herein is omitted.

In the above described embodiment, the reverse flow inhibiting groove 27 is provided in the Tesla valve shape. The shape of the reverse flow inhibiting groove is not restricted to the Tesla valve shape, if the effect of the herein disclosed technique is implemented. FIG. 9 is a plane view of a separator 226. In FIG. 9, a flat surface structure of the separator 226 is partially enlarged so as to be shown. As shown in FIG. 9, the separator 226 includes a reverse flow inhibiting groove 227. In this embodiment, the reverse flow inhibiting groove 227 includes a main pipe 227A and a valve 227B. The main pipe 227A can configure, for example, a flow channel in which the electrolytic solution flows from the outside to the inside of the electrode assembly 20, and a flow channel in which the electrolytic solution flows from the inside to the outside of the electrode assembly 20. The valve 227B is, for example, a portion for inhibiting the electrolytic solution from flowing to the outside from the inside of the electrode assembly 20. In a form shown by FIG. 9, the valve 227B is provided in the main pipe 227A. In FIG. 9, plural valves 227B are provided in one main pipe 227A, but the number of the valves 227B in one main pipe 227A is not particularly restricted, and thus can be suitably changed. Incidentally, as needed, the valves might be provided inside the reverse flow inhibiting groove 27 in the above described embodiment.

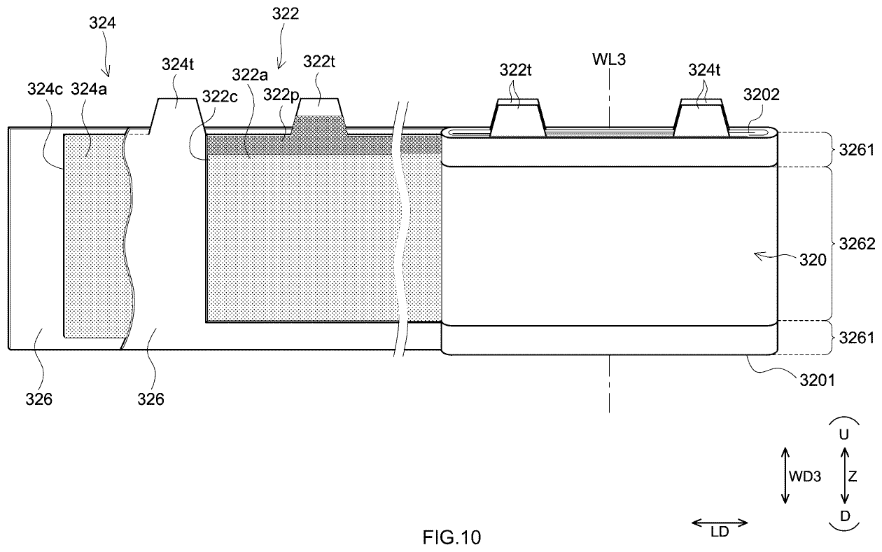

The open surfaces (the first end part 201 and the second end part 202) of the electrode assembly 20 in the above described embodiment are arranged to be opposed to the second side walls 12c of the case 10. However, the shape of the electrode assembly is not restricted to this. FIG. 10 is a schematic view of an electrode assembly 320. As shown in FIG. 10, the electrode assembly 320 is a wound electrode assembly. In a form shown by FIG. 10, regarding the electrode assembly 320, a positive electrode 322 formed in a long sheet shape and a negative electrode 324 formed in a long sheet shape are laminated via a separator 326 formed in a long sheet shape, and then wound in the sheet longitudinal direction. In this embodiment, the electrode assembly 320 is accommodated in the case 10 to make a winding axis WL3 of the electrode assembly 320 and the vertical direction Z of the case 10 be in approximately parallel (see FIG. 1 and FIG. 2).

In this embodiment, the electrode assembly 320 is accommodated in the outer case 12 so as to make a winding axis direction WD3 be in approximately parallel to the first side wall 12b and the second side walls 12c and be in approximately vertical to the bottom part 12a and the sealing plate 14. Thus, a first end part 3201 of the electrode assembly 20 is opposed to the bottom part 12a, and a second end part 3202 is opposed to the sealing plate 14. The first end part 3201 and the second end part 3202 herein are laminate surfaces configured with the positive electrode 322, the negative electrode 324, and the separator 326, and are open surfaces. As shown in FIG. 10, both of a positive electrode tab 322t and a negative electrode tab 324t are provided on the second end part 3202 of the electrode assembly 320. Thus, the positive electrode tab 322t and the negative electrode tab 324t are opposed to the sealing plate 14 (see FIG. 2).

In a form shown by FIG. 10, first areas 3261 on the separator 326 are respectively adjacent to the first end part 3201 and the second end part 3202 of the electrode assembly 320. In the form shown by FIG. 10, the first areas 3261 are areas provided at both ends in the shorter direction of the separator 326 and formed in strip-like shapes along the longitudinal direction of the separator 326. A second area 3262 is, for example, an area of the separator 326 from which the first area 3261 is excluded. In the form shown by FIG. 10, the second area 3262 is sandwiched by the first areas 3261. In this embodiment, the second area 3262 is an area which is sandwiched between the first areas 3261 and which is formed in the strip-like shape along the longitudinal direction of the separator 326. The reverse flow inhibiting groove can be, for example, provided on the first areas 3261. Incidentally, in FIG. 10, a reference sign “322a” represents a positive electrode active material layer, a reference sign “322c” represents a positive electrode collecting foil, a reference sign “322p” represents a protective layer, a reference sign “324a” represents a negative electrode active material layer, and a reference sign “324c” represents a negative electrode collecting foil.

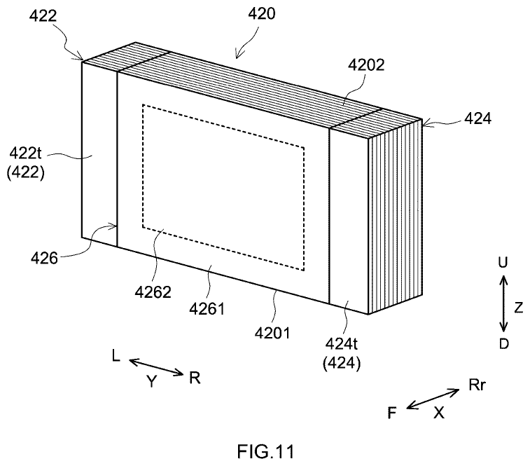

The electrode assembly 20 of the above described embodiment has been the wound electrode assembly. However, a structure of the electrode assembly is not restricted to this. FIG. 11 is a perspective view of an electrode assembly 420. As shown in FIG. 11, the electrode assembly 420 is a laminate electrode assembly. As shown in FIG. 11, the electrode assembly 420 includes a positive electrode 422 formed in a rectangular sheet shape, a negative electrode 424 formed in a rectangular sheet shape, and a separator 426 formed in a rectangular sheet. In this embodiment, the positive electrode 422 and the negative electrode 424 are alternately laminated via the separator 426. In this embodiment, the positive electrode 422 includes a collecting foil exposed part 422t at one of end parts in the long side direction, on which the positive electrode active material layer is not provided. The negative electrode 424 includes a collecting foil exposed part 424t at one of end parts in the long side direction, on which the negative electrode active material layer is not provided. In the electrode assembly 420, the collecting foil exposed parts 422t of the positive electrodes 422 are mutually superimposed, and the collecting foil exposed parts 424t of the negative electrodes 424 are mutually superimposed. In this embodiment, the electrode assembly 420 is accommodated in the case 10 to make the short side direction of the electrode and the vertical direction Z of the case 10 be in approximately parallel and to make the long side direction of the electrode and the long side direction Y of the case 10 be in approximately parallel (see FIG. 1 and FIG. 2).

In this embodiment, regarding the electrode assembly 420, two laminate surfaces (here, a laminate surface at a first end part 4201 and a laminate surface of a second end part 4202) configured with the electrode and the separator, a laminate surface of the collecting foil exposed part 422t of the positive electrode 422, and a laminate surface of the collecting foil exposed part 424t of the negative electrode 424 are open surfaces. Each of 4 open surfaces described above is opposed to the bottom part 12a, the first side wall 12b, or the second side wall 12c of the case 10. Among them, the laminate surface of the collecting foil exposed part 422t of the positive electrode 22 is opposed to one of the second side walls 12c. The laminate surface of the collecting foil exposed part 424t of the negative electrode 24 is opposed to the other one of the second side walls 12c (see FIG. 2).

In a form shown by FIG. 11, the first area 4261 on the separator 426 is provided along a pair of opposed long sides and a pair of opposed short sides. The second area 4262 is, for example, an area of the separator 426 from which the first area 4261 is excluded. In the form shown by FIG. 11, the second area 4262 is surrounded by the first area 4261. The reverse flow inhibiting groove is, for example, provided on the first area 4261.

In the above described embodiment, regarding the separator 26, the first layer 26A and the second layer 26B, which are the adhesion layers, are provided on one surface of the base material 26S. However, a configuration of the separator is not restricted to this. For example, the first layer 26A and the second layer 26B, which are the adhesion layers, might be provided on both surfaces of the base material 26S. Alternatively, between the base material 26S and the adhesion layer, a heat resistance layer might be provided. In a case where the heat resistance layer is provided, it is good that only the adhesion layer is provided on one surface of the base material 26S and only the heat resistance layer is provided on the other surface. It is also good that only the adhesion layer is provided on one surface of the base material 26S, and the heat resistance layer and the adhesion layer are provided on the other surface. Alternatively, it is also good that only the heat resistance layer is provided on the surface of the base material 26S, and the heat resistance layer and the adhesion layer are provided on the other surface. In a case where both of the heat resistance layer and the adhesion layer are provided, it is preferable that the heat resistance layer is provided between the base material 26S and the adhesion layer. Incidentally, as a configuration of the heat resistance layer, a configuration of the heat resistance layer used for this kind of purposes can be applied without particular restriction. The configuration itself of the heat resistance layer is not to characterize the herein disclosed technique, and thus the explanation would be omitted here.

The herein disclosed technique could contain aspects recited in each of items described below.

Item 1: An electric storage device, comprising:
an electrode assembly that comprises a positive electrode, a negative electrode, and a separator insulating the positive electrode from the negative electrode;
an electrolytic solution; and
a case that is configured to accommodate the electrode assembly and the electrolytic solution, wherein
a surface of the separator is provided with a reverse flow inhibiting groove that is a groove in which the electrolytic solution flows from an outside to an inside of the electrode assembly and which is in a pattern for inhibiting the electrolytic solution from flowing to the outside from the inside of the electrode assembly.

Item 2: The electric storage device recited in item 1, wherein
at an edge part of the separator, the reverse flow inhibiting groove is provided on a first area being opened to the outside of the electrode assembly.

Item 3: The electric storage device recited in item 2, wherein
the separator comprises a base material and a first layer on a surface of the base material,
the first layer is provided on the first area, and
the reverse flow inhibiting groove is provided on the first layer.

Item 4: The electric storage device recited in item 2 or 3, wherein
the separator comprises a second area from which the first area is excluded,
on a surface of the base material within the second area, a second layer is provided, and
on the second layer, a groove comprising a pattern different from the reverse flow inhibiting groove is provided.

Item 5: The electric storage device recited in any one of items 1 to 4, wherein
as the electrode assembly, a wound electrode assembly is provided in which the positive electrode in a long sheet shape and the negative electrode in a long sheet shape are laminated with the separator in a long sheet shape interposed therebetween, and then wound in a sheet longitudinal direction.

Item 6: The electric storage device recited in any one of items 1 to 4, wherein
as the electrode assembly, a laminate electrode assembly is provided in which the positive electrode in a rectangular sheet shape and the negative electrode in a rectangular sheet shape are alternately laminated with the separator in a rectangular sheet shape interposed therebetween.

Item 7: The electric storage device recited in any one of items 1 to 6, wherein
the reverse flow inhibiting groove comprises a main pipe, and a sub pipe configured to couple to the main pipe at two positions and in a loop shape,
the main pipe configures a flow channel in which the electrolytic solution flows from the outside to the inside of the electrode assembly and a flow channel in which the electrolytic solution flows from the inside to the outside of the electrode assembly, and
the reverse flow inhibiting groove is configured to make the electrolytic solution flowing in the main pipe dividedly flow from the main pipe to the sub pipe on a first coupling portion arranged at a relatively outer side of the electrode assembly among 2 coupling portions configured with the main pipe and the sub pipe and to make the electrolytic solution flowing in the sub pipe be merged, along a flowing direction of the electrolytic solution flowing in the main pipe, into the electrolytic solution flowing in the main pipe on a second coupling portion arranged at a relatively inner side of the electrode assembly among the 2 coupling portions configured with the main pipe and the sub pipe, in a case where the electrolytic solution flows from the outside to the inside of the electrode assembly, and is configured to make the electrolytic solution flowing in the main pipe dividedly flow from the main pipe to the sub pipe on the second coupling portion and to make the electrolytic solution flowing in the sub pipe be merged into the electrolytic solution flowing in the main pipe, from a backward direction with respect to a flowing direction of the electrolytic solution flowing in the main pipe on the first coupling portion, in a case where the electrolytic solution flows from the inside to the outside of the electrode assembly.

Item 8: The electric storage device recited in any one of items 1 to 6, wherein
the reverse flow inhibiting groove is provided in a Tesla valve shape.

Item 9: A separator used for an electric storage device, the electric storage device comprising:
an electrode assembly that comprises a positive electrode, a negative electrode, and the separator insulating the positive electrode from the negative electrode;
an electrolytic solution; and
a case configured to accommodate the electrode assembly and the electrolytic solution, the separator comprising:
a reverse flow inhibiting groove on a surface that is a groove in which the electrolytic solution flows from an outside to an inside of the electrode assembly and which is in a pattern for inhibiting the electrolytic solution from flowing to the outside from the inside of the electrode assembly.

Item 10: The separator recited in item 9, wherein
the reverse flow inhibiting groove is disposed on a first area configuring an edge part.

Item 11: The separator recited in item 10, comprising a base material, and comprising a first layer on a surface of the base material within the first area, wherein
the reverse flow inhibiting groove is disposed on the first layer.

Item 12: The separator recited in item 10 or 11, comprising a second layer on a second area from which the first area is excluded, wherein
a groove comprising a pattern different from the reverse flow inhibiting groove is provided on the second layer.

Item 13: The separator recited in any one of items 9 to 12, wherein
the reverse flow inhibiting groove comprises a main pipe, and a sub pipe configured to couple to the main pipe at two positions and in a loop shape,
the main pipe configures a flow channel in which the electrolytic solution flows from the outside to the inside of the electrode assembly and a flow channel in which the electrolytic solution flows from the inside to the outside of the electrode assembly, and
the reverse flow inhibiting groove is configured to make the electrolytic solution flowing in the main pipe dividedly flow from the main pipe to the sub pipe on a first coupling portion arranged at a relatively outer side of the electrode assembly among 2 coupling portions configured with the main pipe and the sub pipe and to make the electrolytic solution flowing in the sub pipe be merged, along a flowing direction of the electrolytic solution flowing in the main pipe, into the electrolytic solution flowing in the main pipe on a second coupling portion arranged at a relatively inner side of the electrode assembly among the 2 coupling portions configured with the main pipe and the sub pipe, in a case where the electrolytic solution flows from the outside to the inside of the electrode assembly, and is configured to make the electrolytic solution flowing in the main pipe dividedly flow from the main pipe to the sub pipe on the second coupling portion and to make the electrolytic solution flowing in the sub pipe be merged into the electrolytic solution flowing in the main pipe, from a backward direction with respect to a flowing direction of the electrolytic solution flowing in the main pipe on the first coupling portion, in a case where the electrolytic solution flows from the inside to the outside of the electrode assembly.

Item 14: The separator recited in any one of items 9 to 13, wherein
the reverse flow inhibiting groove is provided in a Tesla valve shape.

What is claimed is:

1. An electric storage device, comprising:
an electrode assembly that comprises a positive electrode, a negative electrode, and a separator insulating the positive electrode from the negative electrode;
an electrolytic solution; and
a case that is configured to accommodate the electrode assembly and the electrolytic solution, wherein
a surface of the separator is provided with a reverse flow inhibiting groove that is a groove in which the electrolytic solution flows from an outside to an inside of the electrode assembly and which is in a pattern for inhibiting the electrolytic solution from flowing to the outside from the inside of the electrode assembly.

2. The electric storage device according to claim 1, wherein
at an edge part of the separator, the reverse flow inhibiting groove is provided on a first area being opened to the outside of the electrode assembly.

3. The electric storage device according to claim 2, wherein
the separator comprises a base material and a first layer on a surface of the base material,
the first layer is provided on the first area, and
the reverse flow inhibiting groove is provided on the first layer.

4. The electric storage device according to claim 3, wherein
the separator comprises a second area from which the first area is excluded,
on a surface of the base material within the second area, a second layer is provided, and
on the second layer, a groove comprising a pattern different from the reverse flow inhibiting groove is provided.

5. The electric storage device according to claim 1, wherein
as the electrode assembly, a wound electrode assembly is provided in which the positive electrode in a long sheet shape and the negative electrode in a long sheet shape are laminated with the separator in a long sheet shape interposed therebetween, and then wound in a sheet longitudinal direction.

6. The electric storage device according to claim 1, wherein
as the electrode assembly, a laminate electrode assembly is provided in which the positive electrode in a rectangular sheet shape and the negative electrode in a rectangular sheet shape are alternately laminated with the separator in a rectangular sheet shape interposed therebetween.

7. The electric storage device according to claim 1, wherein
the reverse flow inhibiting groove comprises a main pipe, and a sub pipe configured to couple to the main pipe at two positions and in a loop shape,
the main pipe configures a flow channel in which the electrolytic solution flows from the outside to the inside of the electrode assembly and a flow channel in which the electrolytic solution flows from the inside to the outside of the electrode assembly, and
the reverse flow inhibiting groove is configured to make the electrolytic solution flowing in the main pipe dividedly flow from the main pipe to the sub pipe on a first coupling portion arranged at a relatively outer side of the electrode assembly among 2 coupling portions configured with the main pipe and the sub pipe and to make the electrolytic solution flowing in the sub pipe be merged, along a flowing direction of the electrolytic solution flowing in the main pipe, into the electrolytic solution flowing in the main pipe on a second coupling portion arranged at a relatively inner side of the electrode assembly among the 2 coupling portions configured with the main pipe and the sub pipe, in a case where the electrolytic solution flows from the outside to the inside of the electrode assembly, and is configured to make the electrolytic solution flowing in the main pipe dividedly flow from the main pipe to the sub pipe on the second coupling portion and to make the electrolytic solution flowing in the sub pipe be merged into the electrolytic solution flowing in the main pipe, from a backward direction with respect to a flowing direction of the electrolytic solution flowing in the main pipe on the first coupling portion, in a case where the electrolytic solution flows from the inside to the outside of the electrode assembly.

8. The electric storage device according to claim 7, wherein
the reverse flow inhibiting groove is provided in a Tesla valve shape.

9. A separator used for an electric storage device, the electric storage device comprising:
an electrode assembly that comprises a positive electrode, a negative electrode, and the separator insulating the positive electrode from the negative electrode;
an electrolytic solution; and
a case configured to accommodate the electrode assembly and the electrolytic solution, the separator comprising
a reverse flow inhibiting groove on a surface that is a groove in which the electrolytic solution flows from an outside to an inside of the electrode assembly and which is in a pattern for inhibiting the electrolytic solution from flowing to the outside from the inside of the electrode assembly.

10. The separator according to claim 9, wherein
the reverse flow inhibiting groove is disposed on a first area configuring an edge part.

11. The separator according to claim 10, comprising a base material, and comprising a first layer on a surface of the base material within the first area, wherein the reverse flow inhibiting groove is disposed on the first layer.

12. The separator according to claim 11, comprising a second layer on a second area from which the first area is excluded, wherein
a groove comprising a pattern different from the reverse flow inhibiting groove is provided on the second layer.

13. The separator according to claim 9, wherein
the reverse flow inhibiting groove comprises a main pipe, and a sub pipe configured to couple to the main pipe at two positions and in a loop shape,
the main pipe configures a flow channel in which the electrolytic solution flows from the outside to the inside of the electrode assembly and a flow channel in which the electrolytic solution flows from the inside to the outside of the electrode assembly, and
the reverse flow inhibiting groove is configured to make the electrolytic solution flowing in the main pipe dividedly flow from the main pipe to the sub pipe on a first coupling portion arranged at a relatively outer side of the electrode assembly among 2 coupling portions configured with the main pipe and the sub pipe and to make the electrolytic solution flowing in the sub pipe be merged, along a flowing direction of the electrolytic solution flowing in the main pipe, into the electrolytic solution flowing in the main pipe on a second coupling portion arranged at a relatively inner side of the electrode assembly among the 2 coupling portions configured with the main pipe and the sub pipe, in a case where the electrolytic solution flows from the outside to the inside of the electrode assembly, and is configured to make the electrolytic solution flowing in the main pipe dividedly flow from the main pipe to the sub pipe on the second coupling portion and to make the electrolytic solution flowing in the sub pipe be merged into the electrolytic solution flowing in the main pipe, from a backward direction with respect to a flowing direction of the electrolytic solution flowing in the main pipe on the first coupling portion, in a case where the electrolytic solution flows from the inside to the outside of the electrode assembly.

14. The separator according to claim 13, wherein
the reverse flow inhibiting groove is provided in a Tesla valve shape.
